(19) United States
(12) Patent Application Publication
(10) Pub. No.: US 2026/0216713 A1
(43) Pub. Date: Jul. 30, 2026

(54) AG/CU-SSZ-13 CATALYST, AND PREPARATION METHOD AND USE THEREOF

(71) Applicant: Beijing University of Technology, Beijing (CN)

(72) Inventors: Guizhen ZHANG, Beijing (CN); Mengyi KOU, Beijing (CN); Liyun SONG, Beijing (CN); Xi HUANG, Beijing (CN); Shuzhen LI, Beijing (CN)

(73) Assignee: Beijing University of Technology, Beijing (CN)

(21) Appl. No.: 19/578,543

(22) Filed: Mar. 25, 2026

(30) Foreign Application Priority Data
Aug. 5, 2025 (CN) 202511093519.3

(51) Int. Cl. B01J 29/76; B01J 37/02; B01J 37/12; C01B 3/047

(52) U.S. Cl. CPC B01J 29/763; B01J 37/0201; B01J 37/12; C01B 3/047

(57) ABSTRACT

Disclosed is an NH3-SCO catalyst, specifically an Ag/Cu-SSZ-13 catalyst, and a preparation method and use thereof. The preparation method comprises calcining a SSZ-13 molecular sieve; mixing silver nitrate, copper nitrate trihydrate, and water, and performing an impregnation; and drying the impregnated material, followed by calcining to obtain an Ag/Cu-SSZ-13 catalyst. The catalyst prepared according to the present disclosure possesses a unique “Ag on the outer surface-Cu in the interior” structure. Ag is predominantly enriched on the surface of the SSZ-13 molecular sieve, which effectively increases the number of adsorption sites on the molecular sieve surface and enhances its redox capacity. Meanwhile, the Cu species located in the interior of the SSZ-13 framework efficiently catalyzes the conversion of NOₓ to N₂. The synergistic effect of Ag—Cu significantly improves the redox ability of the molecular sieve surface and accelerates the reaction step involving the oxidation of NH₃ to NOₓ.

### TECHNICAL FIELD

The present disclosure pertains to the technical field of NH₃-SCO catalyst, particularly to an Ag/Cu-SSZ-13 catalyst, and preparation method and use thereof.

### BACKGROUND

Ammonia (NH₃) is a colorless gas with a pungent odor, widely utilized in the chemical industry, agriculture, and transportation. However, its leakage or excessive emission can lead to air contamination, cause damage to human mucous membranes, and adversely impact the natural environment. Consequently, it is necessary to develop high-performance catalysts for the selective catalytic oxidation of NH₃ to N₂ (NH₃-SCO). Current NH₃-SCO catalysts are primarily classified into three categories: (1) noble metal catalysts (Pt, Pd, Rh, and Au); (2) metal oxide catalysts (CuOₓ, FeOₓ, CoOₓ, and V₂O₅); and (3) molecular sieve catalysts. Each type of catalyst exhibits distinct characteristics: noble metal catalysts demonstrate excellent low-temperature activity (<300° C.), but are costly. While silver-based catalysts offer improved cost-effectiveness among noble metals, single-component silver-based catalysts typically require a loading of more than 10 wt. % to achieve optimal activity, which is necessary to maintain sufficient catalytic performance. Metal oxide catalysts possess good low-temperature activity and are low in cost, yet they suffer from poor N2 selectivity. For the molecular sieve catalysts, such as SSZ-13, ZSM-5, and SAPO-34, these materials are low-cost and feature a high specific surface area. Although they enable efficient dispersion of active metal components, the pure molecular sieve without metal loading exhibits low polarity, resulting in poor conversion in catalytic reactions and low selectivity to N₂. Therefore, to meet increasingly stringent NH₃ emission standards, there is an urgent need for an NH₃-SCO catalyst that offers low cost, high activity, and high N₂ selectivity.

### SUMMARY

An objective of the present disclosure is to provide an Ag/Cu-SSZ-13 catalyst, preparation method and use thereof, to overcome the limitations of existing NH₃-SCO catalysts, including their high cost, inadequate low-temperature catalytic activity, and poor N₂ selectivity.

In order to achieve the above objective, the present disclosure provides a preparation method for an Ag/Cu-SSZ-13 catalyst, the method includes the following preparation steps:
S1, calcining a SSZ-13 molecular sieve to obtain a pretreated SSZ-13 molecular sieve;
S2, mixing silver nitrate, copper nitrate trihydrate, and water, then adding the pretreated SSZ-13 molecular sieve and performing an impregnation to obtain an impregnated material; and
S3, drying the impregnated material, followed by calcining to obtain an Ag/Cu-SSZ-13 catalyst.

In the present disclosure, in S1, a temperature of the calcination is 380-420° C., and a time of the calcination is 1-3 h.

In the present disclosure, in S1, an objective of the calcination is to remove impurities and moisture from the SSZ-13 molecular sieve.

In the present disclosure, in S2, a mass ratio of silver nitrate, copper nitrate trihydrate, and SSZ-13 molecular sieve is 0.10-0.16:0.2-0.4:2.

In the present disclosure, in S2, a temperature of the mixing is 18-25° C., and a time of the mixing is 10-14 min.

In the present disclosure, in S2, after adding the pretreated SSZ-13 molecular sieve, the mixture is stirred for 2-4 min, followed by impregnation.

In the present disclosure, in S2, a temperature of the impregnation is 60-70° C., and a time of the impregnation is 4-6 h.

In the present disclosure, in S3, a temperature of the drying is 60-70° C., and a time of the drying is 10-14 h.

In the present disclosure, in S3, a temperature of the calcination is 500-600° C., and a time of the calcination is 2-4 h.

The present disclosure further provides an Ag/Cu-SSZ-13 catalyst prepared by the preparation method for the Ag/Cu-SSZ-13 catalyst described above.

The present disclosure further provides a use for the Ag/Cu-SSZ-13 catalyst described above in catalytic ammonia.

In the present disclosure, the use of catalytic ammonia includes the catalytic oxidation of ammonia to nitrogen.

The present disclosure has the following beneficial effects:

The present disclosure provides a preparation method for an Ag/Cu-SSZ-13 catalyst, comprising the following steps: the SSZ-13 molecular sieve is calcined to obtain the pretreated SSZ-13 molecular sieve; the silver nitrate, copper nitrate trihydrate, and water are mixed, then the pretreated SSZ-13 molecular sieve is added and the impregnation is performed to obtain the impregnated material; and the impregnated material is dried, followed by calcining to obtain the Ag/Cu-SSZ-13 catalyst. In this present disclosure, Ag ions and Cu ions are loaded onto the SSZ-13 molecular sieve via impregnation. The SSZ-13 molecular sieve, serving as the support, has a pore size of 3.8 Å, while the ionic radii of Cu ions and Ag ions are 0.74 Å and 1.15 Å, respectively. Consequently, during the impregnation process, the larger ionic radius of Ag ions results in greater diffusion resistance into the channels of the SSZ-13 molecular sieve, leading to a slower diffusion rate. In contrast, the smaller ionic radius of Cu ions leads to lower diffusion resistance and a faster diffusion rate. Without external intervention, this difference causes Ag ions to be predominantly distributed on the outer surface of the SSZ-13 molecular sieve, while Cu ions migrate into the interior, thereby forming an Ag/Cu-SSZ-13 catalyst with a localized distribution of Cu and Ag cations.

The hydroxyl (OH) sites on the SSZ-13 molecular sieve primarily consist of weak acid Si—OH, Al—OH sites and strong acid Si—OH—Al sites. During the impregnation process, Ag ions and Cu ions preferentially compete for the strong acid-OH sites. Due to its smaller ionic radius, Cu ions exhibit a stronger competitive ability for the strong acid Si—OH—Al sites and preferentially enter the strong acid-OH sites on the Si—OH—Al in the SSZ-13 molecular sieve. In contrast, Ag ions, having a larger ionic radius, show a weaker competitive ability for the strong acid-OH sites compared to Cu ions. Consequently, Ag ions, with their weaker anchoring ability at —OH sites, tend to occupy the weak acid Si—OH and Al—OH sites on the surface of the SSZ-13 molecular sieve. Moreover, the large specific surface area of the SSZ-13 molecular sieve provides sufficient of weak acid-OH sites for anchoring Ag ions. As a result, both Ag and Cu ions are effectively anchored on the SSZ-13 molecular sieve, ultimately forming an oriented distribution structure characterized by “Ag on the outer surface-Cu in the interior.”

The Ag/Cu-SSZ-13 catalyst prepared according to the preparation method for the Ag/Cu-SSZ-13 catalyst of the present disclosure achieves complete conversion of NH₃ at 209° C., with N₂ selectivity stability exceeding 85%.

The Ag/Cu-SSZ-13 catalyst provided by the present disclosure primarily follows the internal selective catalytic reduction (i-SCR) pathway. Due to the differences in ionic radii between Ag and Cu ions and their respective anchoring abilities to Si—OH—Al sites, a differential distribution is spontaneously formed within the SSZ-13 support via a simple co-impregnation method. Specifically, the Ag component is mainly enriched on the surface of SSZ-13, which effectively increases the number of surface adsorption sites, enhances the redox ability, and promotes the initial adsorption-dehydrogenation process of NH₃ (g)→NH₃ (ad)→NHₓ. And the Ag—Cu synergistic effect significantly improves the surface oxygen activation ability, accelerating the reaction step involving the oxidation of NH₃ to NOₓ. Concurrently, the Cu species located inside the SSZ-13 efficiently catalyzes the conversion of NOₓ to N₂, ultimately achieving excellent NH₃-SCO performance. This unique “Ag on the outer surface-Cu in the interior” distribution pattern is highly matched with the reaction pathway, which explains the mechanism underlying the enhanced catalytic activity and provides new insights for improving N₂ selectivity.

The Ag/Cu-SSZ-13 catalyst provided by the present disclosure possesses an oriented distribution structure characterized by “Ag on the outer surface-Cu in the interior.” This structure is highly compatible with the i-SCR mechanism: the surface Ag ions enhance the redox capacity and provide NH₃ adsorption sites, while the internal Cu ions efficiently convert the reaction intermediate NOₓ into N₂, thereby enabling low-temperature light-off and achieving high catalytic efficiency.

Further detailed descriptions of the technical scheme of the present disclosure can be found in the accompanying drawings and embodiments.

### BRIEF DESCRIPTION OF THE DRAWINGS

FIG. 1 is an X-ray diffraction (XRD) spectrum of the present disclosure;

FIG. 2 is an in situ infrared spectrum of the present disclosure;
wherein (a) in FIG. 2 is an in-situ infrared spectrum of a SSZ-13 molecular sieve, (b) in FIG. 2 is an in-situ infrared spectrum of an Ag-SSZ-13 catalyst, (c) in FIG. 2 is an in-situ infrared spectrum of a Cu-SSZ-13 catalyst, and (d) in FIG. 2 is an in-situ infrared spectrum of an Ag/Cu-SSZ-13 catalyst;

FIG. 3 shows scanning electron microscope (SEM) and Mapping spectra of the present disclosure;
wherein (a) in FIG. 3 is an SEM diagram of the Cu-SSZ-13 catalyst, (b) in FIG. 3 is a distribution diagram of Ag element in the Cu-SSZ-13 catalyst, (c) in FIG. 3 is a distribution diagram of Cu element in the Cu-SSZ-13 catalyst, (d) in FIG. 3 is an SEM diagram of the Ag-SSZ-13 catalyst, (e) in FIG. 3 is a distribution diagram of Cu element in the Ag-SSZ-13 catalyst, (f) in FIG. 3 is a distribution diagram of Ag element in Ag-SSZ-13 catalyst, (g) in FIG. 3 is an SEM diagram of Ag/Cu-SSZ-13 catalyst, (h) in FIG. 3 is a distribution diagram of Cu element in the Ag/Cu-SSZ-13 catalyst, and (i) in FIG. 3 is a distribution diagram of Ag element in the Ag/Cu-SSZ-13 catalyst;

FIG. 4 is an electron paramagnetic resonance (EPR) spectrum of the present disclosure;

FIG. 5 is a ultraviolet-visible (UV-Vis) diffuse reflectance spectrum of the present disclosure;

FIG. 6 is a graph showing results of a catalyst activity test of the present disclosure;
wherein (a) in FIG. 6 is a graph of NH₃ conversion test, and (b) in FIG. 6 is a graph of N2 selectivity test;

FIG. 7 is a graph showing results of H₂-TPR test of the present disclosure;

FIG. 8 is a graph showing results of NH₃-TPD analysis of the present disclosure;
wherein (a) in FIG. 8 is a temperature-programmed desorption (TPD) chart of ammonia, and (b) in FIG. 8 is a bar graph of a quantitative distribution of acid sites.

### DETAILED DESCRIPTION OF THE EMBODIMENTS

The following description of the present disclosure is provided with reference to the accompanying drawings and embodiments. Unless otherwise defined, the technical or scientific terms used in the present disclosure shall be those to which the present disclosure belongs. The features described in the present disclosure or those mentioned in the specific embodiments may be combined arbitrarily. The specific embodiments are provided solely for illustrative purposes and shall not be construed as limiting the scope of the present disclosure.

### Embodiment 1

S1, the pretreated SSZ-13 molecular sieve is obtained by calcining the SSZ-13 molecular sieve at 400° C. for 2 h.
S2, 0.16 g of silver nitrate, 0.38 g of copper nitrate trihydrate, and water are mixed at 25° C. for 12 min. Then, 2 g of the pretreated SSZ-13 molecular sieve is added, and the mixture is continuously stirred for 3 min, followed by impregnation at 70° C. for 5 h. The resulting impregnated material is dried at 65° C. for 12 h to obtain the impregnated material.
S3, the impregnated material is dried at 65° C. for 12 h, and then calcined in a muffle furnace at 550° C. for 3 h to obtain the Ag/Cu-SSZ-13 catalyst.

### Embodiment 2

S1, the pretreated SSZ-13 molecular sieve is obtained by calcining the SSZ-13 molecular sieve at 400° C. for 2 h.
S2, 0.10 g of silver nitrate, 0.23 g of copper nitrate trihydrate, and water are mixed at 25° C. for 12 min. Then, the pretreated SSZ-13 molecular sieve is added, and the mixture is continuously stirred for 3 min, followed by impregnation at 70° C. for 5 h. The resulting impregnated material is dried at 65° C. for 12 h to obtain the impregnated material.
S3, the impregnated material is dried at 65° C. for 12 h, and then calcined in a muffle furnace at 550° C. for 3 h to obtain the Ag/Cu-SSZ-13 catalyst.

### Embodiment 3

S1, the pretreated SSZ-13 molecular sieve is obtained by calcining the SSZ-13 molecular sieve at 420° C. for 3 h.
S2, 0.126 g of silver nitrate, 0.304 g of copper nitrate trihydrate, and water are mixed at 25° C. for 12 min. Then, the pretreated SSZ-13 molecular sieve is added, and the mixture is continuously stirred for 3 min, followed by impregnation at 65° C. for 6 h. The resulting impregnated material is dried at 65° C. for 12 h to obtain the impregnated material.
S3, the impregnated material is dried at 65° C. for 12 h, and then calcined in a muffle furnace at 600° C. for 3 h to obtain the Ag/Cu-SSZ-13 catalyst.

### Comparative Embodiment 1

S1, the pretreated SSZ-13 molecular sieve is obtained by calcining the SSZ-13 molecular sieve at 400° C. for 2 h.
S2, 0.16 g of silver nitrate and water are mixed at 25° C. for 12 min. Then, the pretreated SSZ-13 molecular sieve is added, and the mixture is continuously stirred for 3 min, followed by impregnation at 70° C. for 5 h. The resulting impregnated material is dried at 65° C. for 12 h to obtain the impregnated material.
S3, the impregnated material is dried at 65° C. for 12 h, and then calcined in a muffle furnace at 550° C. for 3 h to obtain the Ag-SSZ-13 catalyst.

### Comparative Embodiment 2

S1, the pretreated SSZ-13 molecular sieve is obtained by calcining the SSZ-13 molecular sieve at 400° C. for 2 h.
S2, 0.38 g of copper nitrate trihydrate, and water are mixed at 25° C. for 12 min. Then, the pretreated SSZ-13 molecular sieve is added, and the mixture is continuously stirred for 3 min, followed by impregnation at 70° C. for 5 h. The resulting impregnated material is dried at 65° C. for 12 h to obtain the impregnated material.
S3, the impregnated material is dried at 65° C. for 12 h, and then calcined in a muffle furnace at 550° C. for 3 h to obtain the Cu-SSZ-13 catalyst.

The catalyst prepared by the Comparative embodiments 1 and 2 is pressed and ground to 40-60 mesh, and the following tests are performed.

### Characterization Test

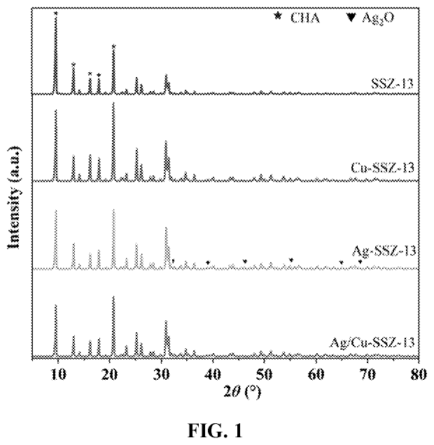

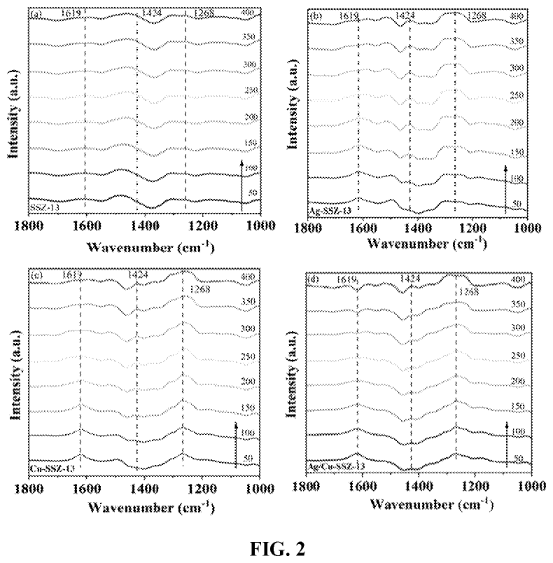

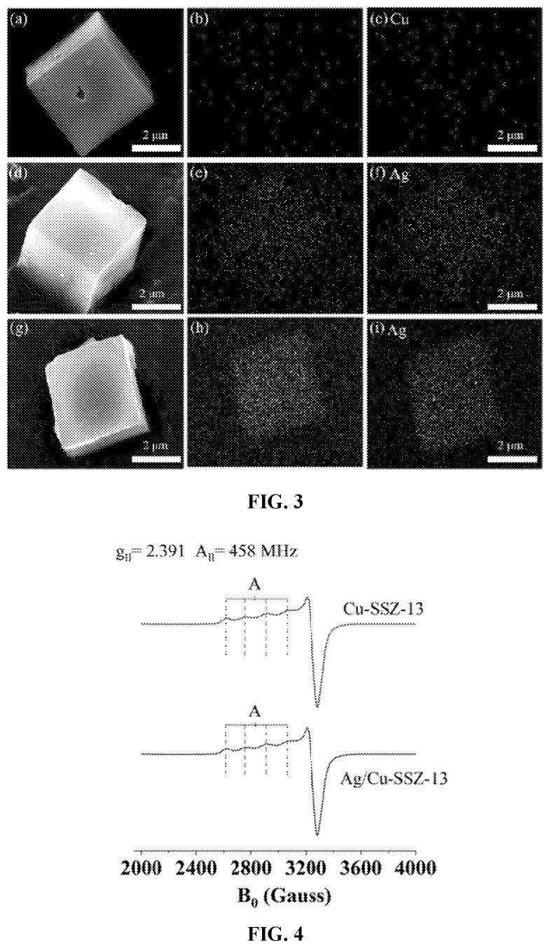

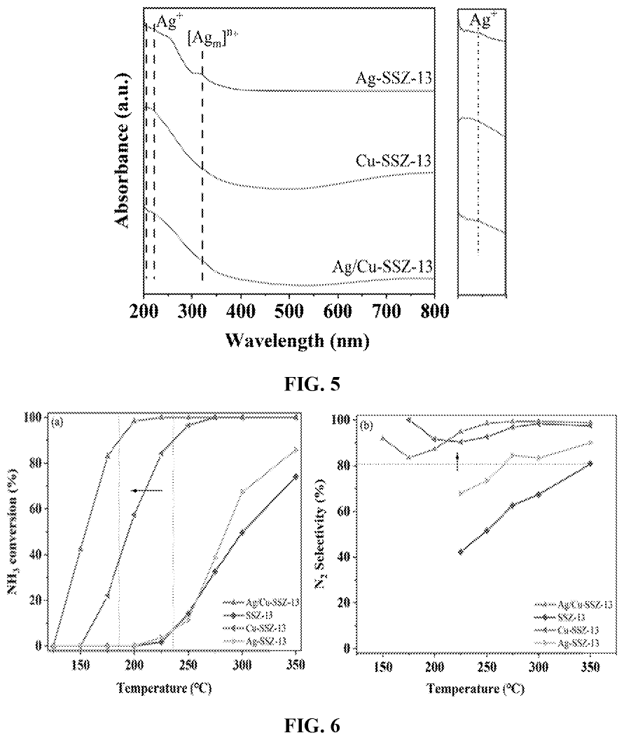

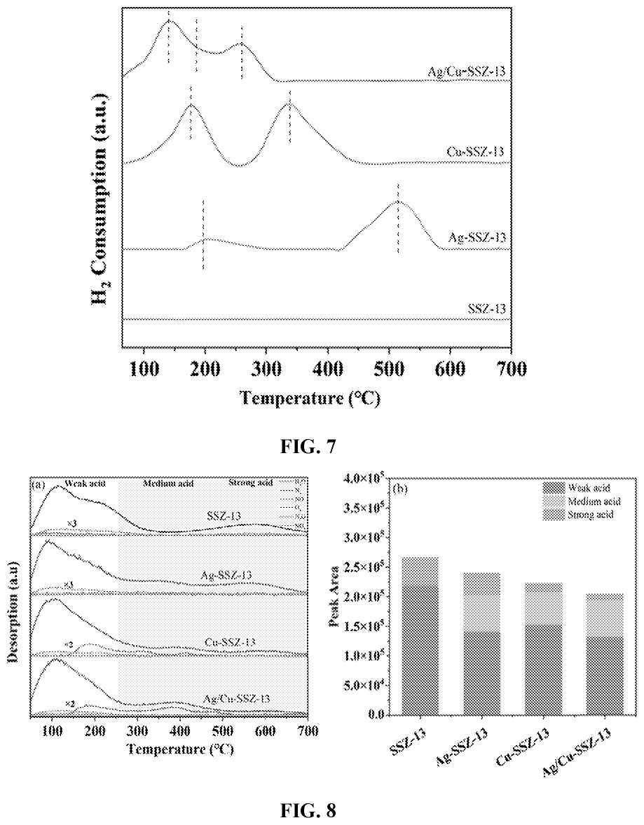

The catalysts prepared in Embodiment 1, Comparative embodiment 1, and Comparative embodiment 2, as well as the SSZ-13 molecular sieve, are subjected to XRD analysis using a Bruker D8 ADVANCE diffractometer with a Cu Kα radiation source (λ=0.15406 nm) (the scanning rate is 5°/min with a step size of 0.02°). The results are shown in FIG. 1. As can be seen from FIG. 1, all samples exhibit the characteristic peaks of the CHA framework structure at angles of 9.5°, 16.2°, 20.8°, 24.9°, and 30.6°, corresponding to the (100), (111), (−210), (211), and (−311) crystal planes, respectively. The metal-supported catalysts (Ag-SSZ-13, Cu-SSZ-13, and Ag/Cu-SSZ-13) retained the CHA framework structure; however, a decrease in peak intensity is observed, indicating a reduction in the crystallinity of the SSZ-13 support due to framework modification during the metal loading process. In the Ag-SSZ-13, characteristic peaks corresponding to Ag₂O are detected at 32.9°, 38.3°, 46.3°, 54.9°, 65.7°, and 68.4° (JCPDS 03-0796), while no metallic Ag peaks are observed. For Cu-SSZ-13, no characteristic diffraction peaks are found for Cu or CuO species, which may be due to the high dispersion of Cu species or specific interactions with the zeolite framework. In the Ag/Cu-SSZ-13 catalyst, neither metal oxide peaks nor metallic peaks are detected, indicating that the preparation method of the present disclosure promotes uniform dispersion of the metals on the SSZ-13 support. These results further confirm that the CHA topology of the SSZ-13 support remains intact after the loading of Ag and Cu, and that the Ag/Cu-SSZ-13 catalyst is successfully prepared.

The NH₃ adsorption/desorption kinetics of the catalysts prepared in Embodiment 1, Comparative embodiment 1, and Comparative embodiment 2, as well as the SSZ-13 molecular sieve, are studied by in situ infrared spectroscopy using a Bruker Tensor II. Prior to measurement, each catalyst sample is pre-treated at 300° C. under a N₂ flow (30 mL/min) for 60 min to eliminate surface contaminants, then cooled to 50° C. under continuous N₂ purge, and background spectra are recorded. Then the catalyst is exposed to a mixed NH₃/N₂ gas (30 mL/min) at 50° C. for 30 min to reach adsorption equilibrium, followed by a N₂ purge for 10 min (30 mL/min) to remove physisorbed NH₃ species. Infrared spectra are collected at 50° C. intervals over a temperature range of 50-400° C. under a N₂ atmosphere, and the results are shown in FIG. 2. As can be seen from FIG. 2, the absorption peak at 1619 cm⁻¹ is attributed to the coordination of NH₃ with metal sites (M-NH₃), while the peak at 1278 cm⁻¹ corresponds to the symmetric bending vibration of NH₃ adsorbed on Lewis acid sites. Cu-SSZ-13 exhibits an NH₃—Cu coordination peak at 1619 cm⁻¹ and a significant enhancement of the Lewis acid site peak at 1278 cm⁻¹. For Ag-SSZ-13, the NH₃—Ag coordination peak appears at 1619 cm⁻¹, but it has no obvious effect on the Lewis acid site (at 1278 cm⁻¹). Ag/Cu-SSZ-13 displays both features, with significantly enhanced peaks at both 1619 cm⁻¹ and 1278 cm⁻¹. The enhanced Lewis acid site (1278 cm⁻¹) in Cu-SSZ-13 is closely related to its i-SCR reaction mechanism. Ag/Cu-SSZ-13 possesses a synergistic enhancement of both the metal site (1619 cm⁻¹) and the Lewis acid site, which explains its optimal NH₃-SCO performance and further confirms the superiority of the bimetallic system. Additionally, all metal-supported catalysts exhibit a characteristic peak of NO₃⁻ at 1424 cm⁻¹, and the formation of NO₃⁻ inhibits the conversion of NH₃ to N₂. Although the SSZ-13 support does not show this peak, this is due to the difficulty in adsorbing NH₃ on its surface for subsequent conversion. Ag/Cu-SSZ-13 shows the lowest NO₃− peak intensity, which changes only when the temperature exceeds 350° C., providing a theoretical basis for its excellent N₂ selectivity.

The structural properties of the catalysts prepared in Embodiment 1, Comparative embodiment 1, and Comparative embodiment 2, as well as the SSZ-13 molecular sieve, are tested using an ASAP 2050 Autosorption Analyzer and a Gemini V Surface Area Analyzer (Micromeritics, USA). For each test, 100-200 mg of the catalyst powder is weighed, pretreated at 110° C. for 1 h to remove adsorbed moisture and impurities, and then analyzed at −196° C. using high-purity N₂ as the adsorbate gas. The results are shown in Table 1.

TABLE 1
Structural properties test results

| Embodiment | BET Surface Area (m²/g) | Pore Volume (cm³/g) |
|---|---|---|
| Embodiment 1 | 434.9 | 0.23 |
| Comparative | 519.1 | 0.29 |
| embodiment 1 | | |
| Comparative | 455.4 | 0.25 |
| embodiment 2 | | |
| SSZ-13 molecular | 548.3 | 0.30 |
| sieve | | |

As can be seen from Table 1, in Comparative embodiment 2, after Cu impregnation, the specific surface area of the SSZ-13 molecular sieve decreases significantly from 548.3 m²/g to 455.4 m²/g, with a corresponding reduction in pore volume to 0.25 cm³/g. This is attributed to the preferential occupation of Cu species at coordination sites within the SSZ-13 framework, particularly those associated with active —OH groups. In contrast, the surface area of the Ag-SSZ-13 molecular sieve is only reduced from 548.3 m²/g to 519.1 m²/g, and the pore volume is slightly decreased from 0.30 cm³/g to 0.29 cm³/g. Combined analysis with FIGS. 1 and 2 indicate that Ag ions mainly exist on the outer surface of the molecular sieve in the form of Ag₂O, with fewer ions entering the interior of the SSZ-13 framework. This is primarily constrained by the diffusion resistance of the SSZ-13 molecular sieve pore channels and the fact that the ionic radius of Ag ions is larger than that of Cu ions. Ag/Cu co-impregnation further reduces the specific surface area of the SSZ-13 molecular sieve to 434.9 m²/g, which results from the combined effects of Cu occupying the strong —OH sites within the framework and Ag covering the outer surface. The adsorption accessibility of N₂ is limited by the cooperative interaction between Cu and Ag. And structural analysis indicates that all samples maintain a high specific surface area above 430 m²/g and an intact channel structure, demonstrating the stability of the overall physical structure of the catalyst, even though the textural parameters are significantly altered by metal impregnation.

The catalysts prepared in Embodiment 1, Comparative embodiment 1, and Comparative embodiment 2 are subjected to quantitative analysis of elemental compositions of Ag and Cu using an Inductively Coupled Plasma-Optical Emission Spectroscopy (ICP-OES), and the results are shown in Table 2.

TABLE 2
ICP-OES analysis results

Content (wt %)

| Embodiment | Ag | Cu |
|---|---|---|
| Embodiment 1 | 4.84 | 4.90 |
| Comparative embodiment 1 | 4.80 | — |
| Comparative embodiment 2 | — | 4.90 |

As can be seen from Table 2, despite the inherent instability of the Ag element, the simultaneous loading of Ag and Cu onto the SSZ-13 molecular sieve is successfully achieved via the co-impregnation method. This yields a bimetallic Ag/Cu-SSZ-13 catalyst with precise metal loadings of 4.84 wt. % Ag and 4.90 wt. % Cu, respectively.

The morphologies of the catalysts prepared in Embodiment 1, Comparative embodiment 1, and Comparative embodiment 2 are characterized using SEM and Mapping techniques, and the results are shown in FIG. 3. As can be seen from FIG. 3, the SSZ-13 molecular sieve support exhibits a distinct cubic morphology with an intact surface structure. After the introduction of Ag, Cu, or Ag/Cu species, the crystal size and macroscopic morphology remain largely unchanged, and the zeolite framework retains its structural integrity throughout the impregnation process. This preservation of structural integrity facilitates adequate contact between reactant molecules and active sites, thereby enhancing the catalytic efficiency of the metal-modified SSZ-13 system. Elemental distribution analysis (FIGS. 3b, 3e, and 3h) reveals differentiated distribution characteristics for Ag and Cu. In the Cu-SSZ-13 catalyst (Comparative embodiment 2) sample (FIGS. 3b, and 3c), the surface distribution of Cu is relatively low, confirming that Cu ions preferentially occupy the internal —OH sites within the framework. In contrast, Ag in the Ag-SSZ-13 catalyst (Comparative embodiment 1) is mainly distributed on the surface of the molecular sieve (FIGS. 3e, and 3f), with only a small amount entering the interior. Notably, this differential distribution is more significant in the bimetallic Ag/Cu-SSZ-13 catalyst (Embodiment 1) (FIGS. 3h, and 3i), where Ag is enriched on the surface while Cu is predominantly localized within the framework.

The catalysts prepared in Embodiment 1 and Comparative embodiment 2 are subjected to EPR test, and the results are shown in FIG. 4. As can be seen from FIG. 4, both the Cu-SSZ-13 catalyst and the Ag/Cu-SSZ-13 catalyst exhibit a characteristic signal (signal A) corresponding to Cu²⁺ species in a tetragonally elongated coordination environment. This spectral feature is indicative of a 5- or 6-coordination configuration, where Cu adopts a square-pyramidal or octahedral geometry within the SSZ-13 molecular sieve framework. These results indicate that Cu is predominantly incorporated into the interior of the molecular sieve and that the coordination state of Cu is not changed by the loading of Ag.

The chemical states of Ag and Cu species in the catalysts prepared in Embodiment 1, Comparative embodiment 1, and Comparative embodiment 2 are studied by UV-Vis diffuse reflectance spectrum, and the results are shown in FIG. 5. As can be seen from FIG. 5, all samples exhibit a significant absorption peak at 210 nm, which is attributed to the charge transfer transition involving framework oxygen atoms, indicating the presence of dispersed monomeric Cu²⁺/Ag⁺ ions on the catalyst surface. Notably, the characteristic peaks appearing in the 220 nm area for the Ag-SSZ-13 and Ag/Cu-SSZ-13 catalyst samples are assigned to the 4d¹⁰(¹S₀)↔4d₉5_{S}_{₁}(₃D₁) electronic transition of isolated Ag⁺ ions. The UV-Vis spectrum of Ag-SSZ-13 shows an additional characteristic peak at 317 nm, which is attributed to the electronic transition of [Agₘ]⁺ clusters. The formation mechanism of these clusters is as follows: during thermal activation, Ag⁺ captures an electron from the zeolite framework oxygen (O⁻+Ag⁺→O+Ag⁰), and the reduced Ag⁰ atoms subsequently aggregate to form metal clusters (nAg⁰+(m−n)Ag+→[Agₘ]ⁿ⁺). Under single-metal Ag loading conditions, Ag preferentially enters the SSZ-13 framework. After high-temperature calcination, the [Agₘ]ⁿ⁺ clusters predominantly reside within the framework interior, while a portion of Ag remains on the catalyst surface as Ag₂O. In contrast, the Ag/Cu-SSZ-13 catalyst does not exhibit significant UV absorption at 317 nm. Combined with XRD and UV-Vis analysis, it indicates that the co-impregnation of Ag and Cu on SSZ-13 molecular sieve effectively promotes the dispersion of Ag and inhibits the formation of [Agₘ]ⁿ⁺ clusters. This occurs because the coexistence of Ag and Cu hinders the electron transfer process between Ag and the framework O, thereby preventing the reduction and aggregation of Ag during thermal activation. Consequently, after high-temperature calcination, Ag in the Ag/Cu-SSZ-13 catalyst primarily exists as Ag₂O on the surface of SSZ-13.

By integrating the UV-Vis spectra with the EPR data, the differential spatial distribution of Cu and Ag within the SSZ-13 molecular sieve framework is revealed, which is fundamentally attributed to the difference in ionic radii between Cu and Ag. During the impregnation process, Cu²⁺, due to its smaller ionic radius and stronger competitive affinity for —OH sites, preferentially enters the interior of SSZ-13 and occupies the —OH sites associated with 6-membered rings (6MR) and 8-membered rings (8MR). In contrast, the larger Ag⁺ primarily forms Ag₂O on the surface of SSZ-13. Consequently, Cu²⁺ is incorporated into the SSZ-13 framework, forming Z₂Cu and ZCuOH species (wherein Z represents the anionic sites of the zeolite framework).

### Catalyst Activity Test

The catalyst activity evaluation device mainly consists of a gas distribution section, a reaction section, and an analysis section. The catalytic performance of the prepared catalysts for the selective catalytic oxidation of ammonia is evaluated in a fixed-bed quartz reactor.

The different reactant gas flows are passed through a mass flow controller to configure the composition of the total gas flow. Wherein the concentration of NH₃ is 500 ppm, the concentration of O₂ is 10% and N₂ as the balance, with a total flow rate of 300 mL/min, corresponding to a gas hourly space velocity (GHSV) of 90,000 mL/(h g). In the test, approximately 100 mg of the catalyst (40-60 mesh) is loaded into a quartz reaction tube (inner diameter=6 mm), which is then placed in an electric furnace. The catalyst is loaded in the middle of the quartz tube and secured with quartz wool using fittings. Both ends of the tube are provided with connections for introducing the simulated gas mixture and for discharging the reaction products. The effluent gas is analyzed online in real time using an FTIR spectrometer (Bruker TENSOR 27) equipped with a 2.4 m path length gas cell. The reaction catalytic temperature is controlled by a temperature controller over the entire temperature range, and steady-state data are collected over the temperature range of 125-350° C. The calculation formulas for the specific catalyst performance parameters are as follows:

(1) NH₃ conversion

$${X}_{{NH}_{3}} = ( 1 - \frac{{[ {NH}_{3} ]}_{out}}{{[ {NH}_{3} ]}_{in}} ) \times 100 \%$$

where [NH₃]ᵢₙ refers to the concentration of NH₃ in the feed, and [NH₃]ₒᵤₜ refers to the concentration of NH₃ after the reaction. The NH₃ conversion curve is plotted with the temperature as the abscissa and the conversion of the reaction gas NH₃ as the ordinate.

The catalytic performance of the catalyst is evaluated by the NH₃ conversion, and the calculation formula is as follows:

### (2) N₂ Selectivity

The overoxidation ability of the catalyst is evaluated by N₂ selectivity, and the calculation formula is as follows:

$${S}_{{N}_{2}} = ( 1 - \frac{{2 [ {N}_{2} O ]}_{out} + {[ NO ]}_{out} + {[ {NO}_{2} ]}_{out}}{{[ {NH}_{3} ]}_{in} - {[ {NH}_{3} ]}_{out}} ) \times 100 \%$$

where [NH₃]ᵢₙ refers to the concentration of NH₃ in the feed, and [NH₃]ₒᵤₜ refers to the concentration of NH₃ after the reaction, [NO]ₒᵤₜ refers to the concentration of NO after the reaction, [NO₂]ₒᵤₜ refers to the concentration of NO₂ after the reaction, and [N₂O]ₒᵤₜ refers to the concentration of N₂O after the reaction. The N₂ selectivity curve is plotted with temperature as the abscissa and N₂ selectivity of the reaction gas as ordinate.

The results of the catalyst activity tests described above are shown in FIG. 6. As can be seen from FIG. 6, the Ag-SSZ-13 (Comparative embodiment 1) and SSZ-13 molecular sieves exhibit significantly lower activity, with initial NH₃ conversion occurring only above 225° C., and complete conversion is not achieved within the temperature range of 125-350° C. The maximum NH₃ conversions achieved by Ag-SSZ-13 and SSZ-13 molecular sieves are 86% and 73%, respectively, with N₂ selectivities below 85%. The Cu-SSZ-13 catalyst (Comparative embodiment 2) achieves complete NH₃ conversion and 96.2% N₂ selectivity at 273° C. In contrast, the Ag/Cu-SSZ-13 catalyst possessing the directional Ag/Cu distribution characteristic (Embodiment 1) demonstrates the optimal catalytic performance, achieving 100% NH₃ conversion and 91% N₂ selectivity at 209° C. These results confirm that the Ag/Cu-SSZ-13 catalyst exhibits excellent low-temperature activity and holds significant application potential.

H₂ temperature-programmed reduction (H₂-TPR) experiments are performed on the catalysts of Embodiment 1, Comparative embodiment 1, and Comparative embodiment 2, as well as on the SSZ-13 molecular sieve, using a Micromeritics AutoChem II 2920 chemisorption analyzer with a thermal conductivity detector (TCD). Approximately 100 mg of each sample is subjected to an oxidative pretreatment at 500° C. in 20 vol % O₂/N₂ for 30 min to remove surface contaminants and establish baseline conditions. Then the sample is cooled to 50° C. under a N₂ flow and stabilized for 20 min. Reduction is performed at ambient temperatures ranging from 50° C. to 700° C. in a 20 vol % H₂/N₂ atmosphere with a heating rate of 5° C./min, during which the H₂ consumption signal is continuously monitored by TCD, and the results are shown in FIG. 7. As can be seen from FIG. 7, no significant hydrogen consumption peak is detected for the SSZ-13 molecular sieve. The Ag-SSZ-13 catalyst exhibits a characteristic reduction peak for Ag₂O at 197° C., and a prominent reduction peak at 514° C., which is attributed to the reduction of [Agₘ]ⁿ⁺ clusters, consistent with the UV-Vis results. The Cu-SSZ-13 catalyst displays two characteristic reduction peaks at 179° C. and 338° C., corresponding to the stepwise reduction process of Cu²⁺ (Cu²⁺→Cu+→Cu⁰). The bimetallic Ag/Cu-SSZ-13 catalyst shows a continuous broad reduction peak in the temperature range of 137-260° C., indicating that the reduction processes of Ag₂O, Cu₂O, and CuO overlap. Notably, the bimetallic loading significantly lowers the reduction temperatures of Ag and Cu. This enhanced reducibility is attributed to two synergistic mechanisms: (1) the bimetallic loading greatly improves the surface oxygen storage capacity of the catalyst, promoting the adsorption of active oxygen species; and (2) the strong electronic interaction between Ag and Cu forms an interfacial charge transfer channel, which significantly accelerates the activation and migration of lattice oxygen.

The catalysts prepared in Embodiment 1, Comparative embodiment 1, and Comparative embodiment 2, as well as the SSZ-13 molecular sieve, are subjected to NH₃-TPD analysis using a TP-5080 fully automated multifunctional adsorption analyzer (Tianjin Xianquan Co., Ltd., China) to evaluate their NH₃ adsorption/desorption capacities, thereby determining the acid sites and oxygen content on the catalyst surface. During the experiment, 100 mg of each sample is pretreated in a He flow (15 mL/min) at 500° C. for 30 min and then cooled to 25° C. The sample is subsequently purged with NH₃ (7 mL/min) for 1 h, followed by heating to 800° C. at a heating rate of 10° C./min. The desorption peaks observed in the temperature range of 100-800° C. are deconvoluted during signal processing to distinguish the acid strength distribution. The results are shown in FIG. 8.

As can be seen from FIG. 8, the desorption peaks below 250° C. correspond to weak acid sites, the peaks in the range of 250-500° C. are assigned to medium-strength acid sites, and the peaks above 500° C. derive from strong acid sites. The SSZ-13 molecular sieve exhibits desorption peaks in both the low-temperature and high-temperature areas, with its acidic sites derived primarily from weak acid sites (Al—OH and Si—OH) and strong Brönsted acid sites (Si—OH—Al). The loading of Ag and Cu results in a decrease in the total acid amount of SSZ-13 but promotes the formation of medium-strength acid sites. For the Ag/Cu-SSZ-13 catalyst, the acid sites are mainly associated with ZCuOH species in the 8MR and Z₂Cu species in the 6MR. During calcination at 550° C., the metastable ZCuOH moieties are removed from the framework, leading to the release of Al and the formation of passivated CuAlO, species, while the highly dispersed surface Cu oxides provide additional medium-strength acid sites. Additionally, after calcination, Ag mainly exists in the form of surface oxides, with only a small amount incorporated into the framework.

The mass spectrometry (MS) data ((a) in FIG. 8) shows that the NO signal is detected during NH₃ desorption for all samples, including the SSZ-13 molecular sieve, Ag-SSZ-13, Cu-SSZ-13, and Ag/Cu-SSZ-13 catalysts. The introduction of Cu promotes the oxidation of NH₃ to NO, which is subsequently converted to N₂ primarily via the i-SCR reaction mechanism. Notably, for the Ag/Cu-SSZ-13 catalyst, N₂ formation is simultaneously observed in the temperature range of 130-500° C. According to the H₂-TPR results, the introduction of Ag significantly enhances the number of adsorption sites and the redox capacity of the catalyst, which effectively promotes the adsorption and oxidation of NH₃ on the Ag/Cu-SSZ-13 catalyst surface.

The NH₃ desorption behaviors of the Ag-SSZ-13, Cu-SSZ-13, and Ag/Cu-SSZ-13 catalysts are studied over a temperature range of 50-400° C. It is found that the intensity of the NH₃ coordination peak at 1619 cm⁻¹ for Ag-SSZ-13 and Cu-SSZ-13 gradually decreases with increasing temperature and basically disappears at 300° C. and 250° C., respectively. In contrast, the characteristic peak for Ag/Cu-SSZ-13 completely disappears at 200° C. NH₃-TPD analysis reveals that the introduction of Cu and Ag significantly enhances the medium-strength acid sites of the catalyst, thereby improving the NH₃-SCO reaction activity. Combined with the in situ DRIFTS results, the absorption peak at 1619 cm⁻¹ is assigned to Cu²⁺—NH₃ or Ag+—NH₃ coordination complexes. The Ag—Cu synergistic effect in Ag/Cu-SSZ-13 accelerates the activation of metal-coordinated ammonia, which undergoes complete desorption and participates in the NH₃-SCO reaction below 250° C., being a key factor in the improved low-temperature catalytic performance. Although Cu-SSZ-13 exhibits an enhanced Lewis acid site characteristic peak at 1268 cm⁻¹ (corresponding to L-NH₃ species), this species possesses exceptional thermal stability and remains stable up to 350° C., making it difficult to participate in the reaction. Ag/Cu-SSZ-13 overcomes this limitation through a dual mechanism: on one hand, the metal-coordinated ammonia at 1619 cm-1 completes desorption and participates in the reaction below 250° C.; on the other hand, the Ag—Cu synergistic effect lowers the activation energy for L-NH₃ desorption, allowing the Lewis acid site at 1268 cm⁻¹ to begin releasing NH₃ after desorption of the metal coordination species, thereby achieving a continuous ammonia supply throughout the entire temperature window. This continuous NH₃ desorption process ensures a steady supply of reactants, rendering the bimetallic catalyst significantly more efficient than single-metal systems. The synergistic combination of Ag and Cu not only optimizes the distribution of acid sites but also establishes a temperature-segmented activation mechanism, which is the key reason for the excellent low-temperature NH₃-SCO performance of Ag/Cu-SSZ-13.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A preparation method for an Ag/Cu-SSZ-13 catalyst, comprising the following preparation steps:
S1, calcining a SSZ-13 molecular sieve to obtain a pretreated SSZ-13 molecular sieve;
S2, mixing silver nitrate, copper nitrate trihydrate, and water, then adding the pretreated SSZ-13 molecular sieve and performing an impregnation to obtain an impregnated material; and
S3, drying the impregnated material, followed by calcining to obtain an Ag/Cu-SSZ-13 catalyst.

2. The preparation method for an Ag/Cu-SSZ-13 catalyst according to claim 1, wherein in S1, a temperature of the calcination is 380-420° C., and a time of the calcination is 1-3 h.

3. The preparation method for an Ag/Cu-SSZ-13 catalyst according to claim 1, wherein in S2, a mass ratio of silver nitrate, copper nitrate trihydrate, and SSZ-13 molecular sieve is 0.10-0.16:0.2-0.4:2.

4. The preparation method for an Ag/Cu-SSZ-13 catalyst according to claim 1, wherein in S2, a temperature of the impregnation is 60-70° C., and a time of the impregnation is 4-6 h.

5. The preparation method for an Ag/Cu-SSZ-13 catalyst according to claim 1, wherein in S3, a temperature of the drying is 60-70° C., and a time of the drying is 10-14 h.

6. The preparation method for an Ag/Cu-SSZ-13 catalyst according to claim 1, wherein in S3, a temperature of the calcination is 500-600° C., and a time of the calcination is 2-4 h.

7. An Ag/Cu-SSZ-13 catalyst prepared by the preparation method for the Ag/Cu-SSZ-13 catalyst according claim 1.

8. A use for the Ag/Cu-SSZ-13 catalyst according to claim 7 in catalytic ammonia.
